(19) United States
(12) Patent Application Publication
(10) Pub. No.: US 2004/0165749 A1
(43) Pub. Date: Aug. 26, 2004

(54) Device and method for vision enhancement and for determining the weather situation

(75) Inventors: Michael Holz, Senden (DE); Joerg Moisel, Neu-Ulm (DE); Michael Weidel, Senden (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/762,607

(22) Filed: Jan. 22, 2004

(30) Foreign Application Priority Data
Jan. 24, 2003 (DE) 103 03 047.6

(51) Int. Cl. G06K 9/00

(52) U.S. Cl. 382/104

(57) ABSTRACT

A method and a device for vision enhancement in a motor vehicle. Image data are detected from the surroundings, and additionally the weather situation is determined from image data, one or more areas of an image and/or a plurality of images recorded at different points in time being compared for determining the weather situation.

Priority is claimed to German Patent Application No. DE 103 03 047.6, filed Jan. 24, 2003, the entire disclosure of which is incorporated by reference herein.

### BACKGROUND

The present invention relates to a method and a device for enhancing vision in motor vehicles, the weather situation being additionally determined from image data.

Vision-enhancement devices and methods for vehicles have been disclosed in various documents of the related art and many of them have been also implemented in mass-produced vehicles. For example, DE 100 02 069 A1, which is incorporated by reference herein, describes a system for vision enhancement in vehicles, in which pulsed infrared radiation is emitted using an illuminating optical system, and the traffic scene thus illuminated is detected by a receiving optical system and presented to the driver.

Rain sensors have been used for determining the weather situation in various mass-produced vehicles for some time. One possible operating principle of these rain sensors calls for the windshield of a vehicle to be used as a planar light waveguide between a radiation emitting transmitter and a receiver. The occurrence of rain is detected from the decoupling loss of this waveguide caused by droplet formation on the windshield. Other optical rain sensors detect a section of the windshield using a camera and evaluate the image thus obtained for the presence of rain droplets. The recording of objects from the surroundings of the vehicle is deliberately suppressed (cf. EP 0 832 798 B 1, which is incorporated by reference herein).

A first approach to combining vision-enhancement systems and systems for determining the weather situation is described in DE 101 04 734 A1, which is incorporated by reference herein. The method described therein is based on the fact that the image data of an image recorded by a camera has different characteristics depending on the current weather situation. In particular, the above-named patent application explains that the contrast of an image is reduced, for example, in the event of deteriorating visibility conditions due to rain or fog. Furthermore, according to the above-mentioned document, the data obtained from the image-recording system is used for controlling vehicle components, for example, a windshield wiper. However, DE 101 04 734 A1 provides no specific method for determining the intensity of precipitation, for example, or for making a distinction between rain and fog.

### SUMMARY OF THE INVENTION

An object of the present invention is to provide a method and a device that permit the different weather situations to be reliably determined using a vision-enhancement system for vehicles.

The present invention provides a method for vision enhancement in motor vehicles, image data being detected from the surroundings and additionally the weather situation being determined from the image data, wherein the image data of one or more areas of an image and/or a plurality of images recorded at different points in time are compared for determining the weather situation. The present invention also provides a device for vision enhancement in motor vehicles having an image-recording device and an analyzer device, wherein the analyzer device is suitable for comparing image data of one or more areas of an image and/or a plurality of images recorded at different points in time for determining the weather situation.

The method according to the present invention permits information on the current weather situation to be obtained from an additional evaluation of image data from the surroundings of a vehicle. For this purpose, image data of one or more areas of an image delivered by a vision-enhancement system and/or image data of a plurality of images recorded at different points in time are compared.

### BRIEF DESCRIPTION OF THE DRAWING

The present invention is described in more detail below with references to the drawings, in which:

FIG. 1 shows a device for vision enhancement in a motor vehicle according to the present invention.

### DETAILED DESCRIPTION

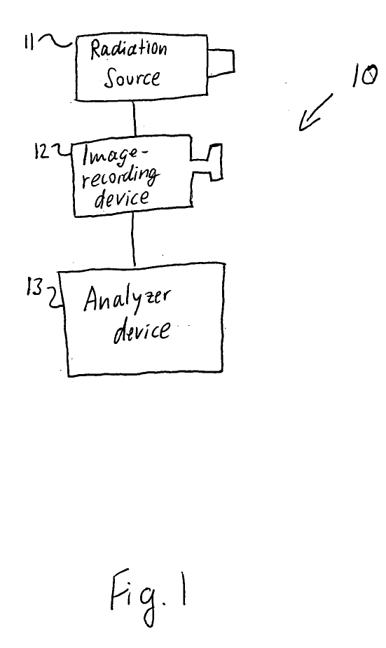

The device 10 for vision enhancement in a motor vehicle shown in FIG. 1, includes a radiation source 11, which emits radiation, which may be infrared radiation, to at least partially illuminate a field detected by image-recording device 12. Image-recording device 12 is configured to record a first image data of a first image area representing at least a portion of a first image. The image-recording device is also configured to record a second image data of a second image area. The second image area represents a portion of the first image and/or at least a portion of a second image recorded at a different point in time. Analyzer device 13 is configured to compare the first image data with the second image data so as to determine a weather situation.

The fact that, for example, rain droplets on a windshield or a camera lens cause a marked change in the image data of a recorded image is advantageously used. In the event of rain, droplets accumulate on the windshield and are periodically removed by the windshield wiper. The thin water film remaining on the windshield after wiping has no effect on the characteristics of the images recorded. In contrast, the droplets on the windshield cause the light beams going through the water droplets to be defocused, which means that the image in this area becomes fuzzy, less bright overall, or streaks appear in the image. Usually this effect of a raindrop is limited to one image area and does not affect the entire image.

The weather situation “rain” can thus be reliably recognized by appropriately evaluating the image data. It is not necessary to focus the camera on the windshield; instead, the camera may be used as before for recording the vehicle's surroundings for vision enhancement. The method according to the present invention thus permits adding another sensor functionality to the vision-enhancement system without substantial changes in the hardware of an existing vision-enhancement system; it is implementable in a simple manner in an existing system with the aid of suitable image-processing software.

In doing so, the image may be divided into a plurality of areas to enhance the performance of the method. This makes it possible to reliably distinguish rain from fog, for example; due to the typically non-homogeneous distribution of raindrops on a vehicle windshield, the image data from different areas of the windshield have different characteristics. By suitably selecting the dimensions of the image area considered, it may be achieved, for example, that one or more droplets on the windshield are already present in one area, while another area is still completely dry. The image data of the areas considered thus differ considerably. In contrast, the image data from different areas of the image usually have similar characteristics for the weather situation “fog.” By comparing different areas of an image, it is thus possible to distinguish rain from fog in a simple manner just using image-processing means. Likewise, images recorded at different points in time may also be used for determining the weather situation. For example, in the event of rain, the image data from images recorded consecutively will differ considerably, while this phenomenon is usually less pronounced or non-existent in the event of fog. A sudden change in the image data, for example, such as a change within a second or from one image to the next, is interpreted as rain, while a fog situation is detected by a slow, continuous change in the image data.

By combining the analysis of different areas of an image with the comparison of a plurality of images or image areas taken at different points in time it is possible to further improve the method according to the present invention with regard to reliably making a distinction between different weather situations.

An advantageous method for comparing image data is determining an index M for the sharpness, i.e., contrast, of the image. Index M computed from the image data may then be used in a simple manner for determining the current weather situation; it may be compared, for example, with certain threshold values or value ranges for the weather situations “fog” or “rain.”

It has proven to be particularly useful to determine M from the differences between the intensities of adjacent or surrounding pixels. For this purpose, advantageously the following method is used: the relative intensity differences of adjacent pixels are first determined for an image area, which may also include the entire image. For the sake of simplicity, the description that follows is limited to a column of 800 pixels. For the 800 pixels considered, the relative intensity differences of adjacent pixels, normalized to the maximum or to the sum of the two intensities, for example, are determined as percentages. Subsequently, the number of pixel pairs for which the relative intensity differences exceed a certain percent value is determined. For example, a relative intensity difference of 3%, 5%, or 10% may be used as the threshold value. The index may be directly determined from the number of pixel pairs that exceed this threshold. In considering the individual image areas, possibly of different sizes, the index must be normalized. For example, the index may be related to the total number of pixel pairs compared. If, for instance, in this example 100 of the 800 relative intensity differences exceed a value of 5%, a value of 0.125 or 12.5% is obtained for the normalized index.

Index M thus determined permits the image data to be evaluated regarding the weather situation in a simple manner. The image is to be divided into a plurality of individual areas, for example, M being determined separately for each area. In the event of rain it is to be expected that, due to the inhomogeneous distribution of the raindrops on the windshield, substantially differing indexes for one image will be determined for the individual areas. Because fog typically affects the entire image homogeneously, in this case the indexes for different image areas of one image will differ from each other considerably less or even negligibly. This permits a reliable distinction between rain and fog using a simple criterion. The corresponding hardware and method complexity may thus be significantly reduced.

The chronological sequence of image data and thus of the index may also be advantageously used for determining the current weather situation. The contrast and thus the index typically changes considerably from one image to the next due to the raindrops hitting the windshield. In contrast, this change in the index occurs considerably more slowly and more continuously in the event of fog. The variation of M over time thus represents an additional criterion for distinguishing between different weather situations. In addition, this procedure permits the intensity of precipitation to be determined in a simple manner. The intensity of precipitation may be derived without major effort from the variation of index M of individual image areas or entire images over time.

Combining the analysis of the index over the area and over time increases the recognition reliability for different weather situations.

The index may be particularly advantageously used for activating or controlling certain vehicle components. For example, it has proven to be useful to turn on the windshield wiper of a vehicle automatically when the start of rain is detected by the method according to the present invention. On the basis of the above-described method for determining the intensity of precipitation from the index it is also advantageous to adjust the windshield wiper speed accordingly. Similarly, when fog is detected by the method according to the present invention, the fog lights may be turned on. In another advantageous variant, components of a vision-enhancement system such as a headlight, for example, may be controlled according to the current weather situation.

Image data recorded within a certain time period before or after an action of a vehicle component may be advantageously used to determine the index. It has been found particularly advantageous, for example, to use the situation immediately after a wiping action of the windshield wiper for improving the method. The fact that the thin water film remaining on the windshield after the wiping action does not affect the image quality may be utilized for using the time period immediately after a wiping action for comparing the image data of a plurality of images following the wiping action. The image data recorded immediately after the wiping action may be used as reference data, which further improves the reliability of the method according to the present invention.

It is also advantageous to adapt the image display and any image data processing to the prevailing weather situation. For example, it is desirable to select certain parameters for the image processing as a function of the current weather situation. For example, it has been found useful depending on the weather situation to assign different values for displaying the image in an image-display device to certain intensity values determined by an image-recording device as a function of the weather situation. For this purpose, the current weather situation in the surroundings of the vehicle must be determined. This is accomplished in a simple manner, because the above-described method permits the weather situation to be determined from the image data; in particular, data delivered by separate sensors does not need to be used.

In a further advantageous embodiment of the present invention, different pieces of information or driver instructions are displayed to the driver as a function of the current value of index M. It is particularly advantageous here to display the guideline speeds recommended for the particular situation, which are stored in a memory unit, for example, for the particular weather situation; it has been found that many drivers drive in fog or rain at a speed that is excessively high for the given situation. The method according to the present invention may thus substantially contribute to traffic safety.

The method is advantageously applicable in particular in devices for vision enhancement in motor vehicles. The device according to the present invention has an image-recording device and an analyzer device. The analyzer device is suitable for comparing image data of one or more areas of the image or of a plurality of images recorded at different points in time to determine the weather situation. For this purpose, the analyzer device has interfaces for supply of image data, a processor unit for analyzing the image data, and a memory unit, which permits storing the determined parameters, in particular indexes M, thus making it possible to compare the image data of a plurality of images recorded at different points in time or of different image areas. The device according to the present invention thus combines rain sensor functionality with vision enhancement functionality, making it unnecessary to install an additional rain sensor in vehicles equipped with this device.

It is particularly advantageous to implement the device according to the present invention as an infrared vision-enhancement system. For this purpose, the image-recording device is implemented as an infrared camera, for example. The device therefore has particularly positive characteristics, in particular for use as a night-vision system—images having a higher informational content compared to conventional images taken in the visible spectrum, for example, are obtainable even at nighttime from the infrared radiation emitted or scattered by objects in the vehicle's surroundings.

In a further advantageous embodiment of the present invention, a radiation source is additionally provided, which at least partly illuminates the area detected by the image-recording device. This illumination may be limited in time and/or place (for example, 50 ms every second or only in a certain image area) in order not to substantially impair the functionality of the vision-enhancement system. It is thus advantageous, for example, to briefly suppress the display of the image recorded by the image-recording device during illumination by the additional radiation source. This corresponds to switching the system over to a “rain sensor mode.” Using this procedure, driver irritation due to the additional radiation recorded by the vision-enhancement system is avoided.

It has also been found useful to use an infrared light source as the additional radiation source.

First, when the device according to the present invention is implemented as an infrared night-vision system, because of the sensitivity of the image-recording device in the infrared spectral range, a source emitting in this range must be used as the additional radiation source; second, with this choice of the emitted radiation, irritation of the vehicle's driver or of the surrounding traffic is largely avoided due to the short radiation pulses for weather determination (rain sensor mode). In this way, the device according to the present invention contributes to both active and passive traffic safety.

What is claimed is:

1. A method for vision enhancement in a motor vehicle, comprising:
recording a first image data of a first image area, the first image area representing at least a portion of a first image;
recording second image data of a second image area, the second image area representing at least one of a portion of the first image and at least a portion of a second image recorded at a different point in time;
comparing the first set of image data with the second set of image data so as to determine a weather situation.

2. The method as recited in claim 1, wherein the comparing is performed using an index of a sharpness of at least one of the first and second images.

3. The method as recited in claim 2, further comprising comparing a difference between an intensity of a first pixel with an intensity of at least one of an adjacent and a surrounding pixel.

4. The method as recited in claim 1, further comprising:
determining a variation of at least one of the first and second image data over time so as to determine an intensity of a precipitation.

5. The method as recited in claim 2, further comprising controlling at least one vehicle component using the index.

6. The method as recited in claim 2, selecting a parameter for image processing using the index.

7. The method as recited in claim 2, further comprising determining the index using at least one of the first and second image data, wherein the first and second image data are recorded within a predetermined time period.

8. The method as recited in claim 2, wherein at least one of the first and second image data is recorded after an action of the vehicle, and further comprising determining the index using at least one of the first and second image data.

9. The method as recited in claim 2, further comprising presenting a user with at least one of a piece of information and an instruction as a function of the index.

10. A device for vision enhancement in a motor vehicle, comprising:
an image-recording device configured to record a first image data of a first image area, the first image area representing at least a portion of a first image, and to record a second image data of a second image area, the second image area representing at least one of a portion of the first image and at least a portion of a second image recorded at a difference point in time; and
an analyzer device configured to compare the first image data with the second image data so as to determine a weather situation.

11. The device as recited in claim 10, wherein the image-recording device is an infrared camera.

12. The device as recited in claim 10, further comprising a radiation source to at least partially illuminate a field detected by the image-recording device.

13. The device as recited in claim 12, wherein the radiation source emits infrared radiation.
